(19) United States
(12) Patent Application Publication
(10) Pub. No.: US 2018/0062762 A1
(43) Pub. Date: Mar. 1, 2018

(54) OPTICAL SIGNAL RECEIVING APPARATUS FOR RECEIVING OPTICAL SIGNAL IN BURST MODE

(71) Applicant: ELECTRONICS AND TELECOMMUNICATIONS RESEARCH INSTITUTE, Daejeon (KR)

(72) Inventors: Sil Gu MUN, Daejeon (KR); Hwan Seok CHUNG, Daejeon (KR)

(21) Appl. No.: 15/685,452

(22) Filed: Aug. 24, 2017

(30) Foreign Application Priority Data
Aug. 29, 2016 (KR) 10-2016-0110112
Jul. 26, 2017 (KR) 10-2017-0094710

(51) Int. Cl. H04B 10/69

(52) U.S. Cl. CPC H04B 10/69; H04B 10/6933

(57) ABSTRACT

An optical signal receiving apparatus included in an optical line terminal (OLT) includes a resistor disposed between a capacitor connected to a receiving optical sub-assembly (ROSA) and a limiting amplifier, wherein a resistance value of the resistor may be determined based on the OLT receives an optical signal from an optical network unit (ONU) and whether the ONU transmitting the optical signal to the OLT is switched, the resistance value of the resistor may be determined to reduce a data loss occurring from the optical signal receiving apparatus in response to the OLT receiving the optical signal from the ONU, and the resistance value of the resistor may be determined such that the optical signal receiving apparatus more rapidly follows a change in intensity of the optical signal in response to the ONU transmitting the optical signal to the OLT being switched.

### CROSS-REFERENCE TO RELATED APPLICATION(S)

This application claims the priority benefit of Korean Patent Application No. 10-2016-0110112 filed on Aug. 29, 2016, and Korean Patent Application No. 10-2017-0094710, filed on Jul. 26, 2017, in the Korean Intellectual Property Office, the disclosures of which are incorporated herein by reference for all purposes.

### BACKGROUND

### 1. Field

One or more example embodiments relate to a passive optical network (PON).

### 2. Description of Related Art

An amount of certain types of content including images, voices, and data has increased exponentially. Since the time smartphones became available, various applications for smartphones have been developed, and accordingly, the volume of wired network traffic has increased and it is desirable to provide a high-bandwidth wired network that is capable of using more bandwidth and thereby smoothly accommodating the additional traffic, for each subscriber.

A wired network structure for providing a high-bandwidth network for each subscriber includes a structure that uses a time-division multiplexing method provided in a related passive optical network (PON) and a structure that uses a time-division multiplexing method combined with a wavelength division multiplexing method, which are currently standardized. The structure using the time-division multiplexing method includes a plurality of optical network units (ONUs) connected to one optical line terminal (OLT). A distance between each of the ONUs and the OLT may vary.

Because the distance between each of the ONUs and the OLT varies, optical powers and polarization features of upstream optical signals transmitted from each of the ONUs to the OLT may vary. Thus, the OLT may include an optical signal receiving apparatus operating in a burst mode to be able to receive the upstream optical signals having different optical powers and different polarization features using one receiving apparatus.

### SUMMARY

An aspect provides an optical signal receiving apparatus for minimizing a deterioration in a receiving sensitivity.

According to an aspect, there is provided an optical signal receiving apparatus including a receiving optical sub-assembly (ROSA) configured to convert an optical signal transmitted during a time interval allocated to each of a plurality of optical network units (ONUs) into an electric signal, a capacitor connected to the ROSA, an amplifier configured to amplify an electric signal output from the capacitor, a clock data generator configured to generate a clock signal and a data signal from the electric signal output from the amplifier, and a resistor connected between the capacitor and the amplifier, wherein a resistance value of the resistor is changed based on whether the time interval is switched.

The resistance value of the resistor may be changed to be a first resistance value set in advance in response to the time interval being switched, and changed to be a second resistance value greater than the first resistance value while receiving the optical signal during a switched time interval in response to switching of the time interval being completed.

The first resistance value may be determined based on intensities of optical signals generated by the ONUs.

The second resistance value may be determined based on a number of ones or zeroes that are sequentially included in the optical signal in response to the optical signal received during the switched time interval sequentially including ones or zeroes.

According to some example embodiments, it is possible to prevent a deterioration in a receiving sensitivity of an optical line terminal (OLT) by changing an optical signal receiving apparatus of the OLT at a low cost without correcting an upper layer.

According to some example embodiments, it is possible that an OLT receives an optical signal of an optical network unit (ONU) located at a greater distance.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a structure of an optical signal receiving apparatus according to an example embodiment;

FIG. 2 illustrates a process in which a resistance value of a resistor of an optical signal receiving apparatus is changed based on a digital value included in an optical signal according to an example embodiment;

FIG. 3 illustrates a process in which a resistance value of a resistor of an optical signal receiving apparatus is determined based on burst mode optical signals received from different optical network units (ONUs) according to an example embodiment; and

FIG. 4 is a flowchart illustrating an operation of an optical signal receiving apparatus according to an example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions may not be described in detail because they would obscure the description with unnecessary detail.

The terminology used herein is for the purpose of describing the example embodiments only and is not intended to be limiting of the disclosure. As used herein, the singular forms “a,” “an,” and “the” are intended to include the plural forms as well, unless the context clearly indicates otherwise. It will be further understood that the terms “include/comprise” and/or “have,” when used in this disclosure, specify the presence of stated features, integers, steps, operations, elements, components, or combinations thereof, but do not preclude the presence or addition of one or more other features, integers, steps, operations, elements, components, and/or groups thereof. In addition, the terms such as “unit,” “-er (-or),” and “module” described in the specification refer to an element for performing at least one function or operation, and may be implemented in hardware, software, or the combination of hardware and software.

Terms such as first, second, A, B, (a), (b), and the like may be used herein to describe components. Each of these terminologies is not used to define an essence, order or sequence of a corresponding component but used to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments are described in detail with reference to the accompanying drawings. Like reference numerals in the drawings denote like elements, and a known function or configuration will be omitted herein.

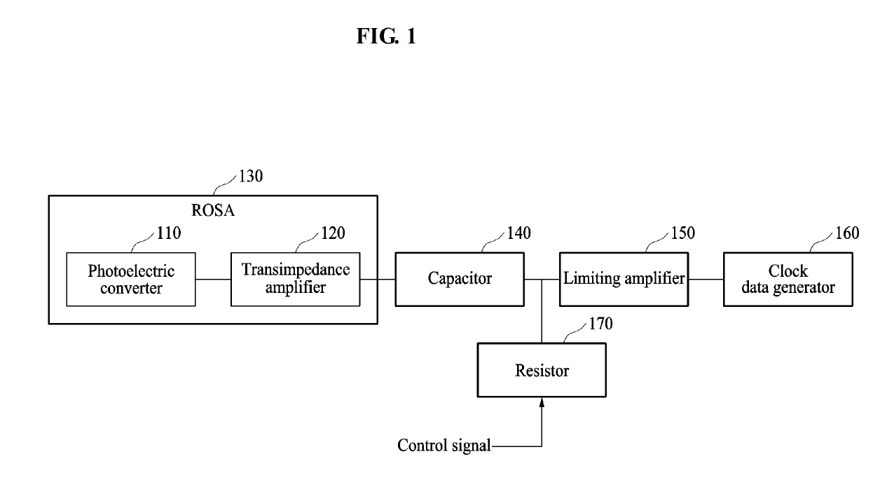

FIG. 1 is a block diagram illustrating a structure of an optical signal receiving apparatus according to an example embodiment. An optical network unit (ONU) may transmit an upstream optical signal toward an optical line terminal (OLT) from the ONU to the OLT within a time slot allocated to each of ONUs. When a plurality of ONUs is connected to the OLT, different time slots may be allocated to the respective ONUs. Thus, the ONUs may transmit respective upstream optical signals to the OLT in different time slots. The upstream optical signals transmitted to the OLT in different time slots by the ONUs are referred to as burst mode optical signals.

The optical signal receiving apparatus is included in the OLT to receive burst mode optical signals generated by at least one ONU connected to the OLT. Referring to FIG. 1, the optical signal receiving apparatus includes a photoelectric converter 110 configured to convert the received optical signal into an electric signal. The photoelectric converter 110 includes any one of a photodiode (PD), for example, an avalanche PD (APD), and a pin PD. A size of a current of an electric signal output by the photoelectric converter 110 may be changed based on the optical signal. Referring to FIG. 1, the optical signal receiving apparatus includes a transimpedance amplifier (TIA) 120 configured to convert or amplify the electric signal output by the photoelectric converter 110. In response to the electric signal output by the photoelectric converter 110 being a current signal that a size of current is changed based on the input optical signal, the transimpedance amplifier 120 may convert the current signal of the photoelectric converter 110 into a voltage signal to be output. That is, a level of voltage of the electric signal output by the transimpedance amplifier 120 may be changed based on the optical signal.

The photoelectric converter 110 and the transimpedance amplifier 120 of the optical signal receiving apparatus may be provided in a receiving optical sub-assembly (ROSA) 130 being one package. Referring to FIG. 1, the optical signal receiving apparatus includes a capacitor 140 connected to the ROSA 130. The capacitor 140 may be a coupling capacitor configured to adjust a voltage level of an output electric signal of the ROSA 130, that is, the electric signal output by the transimpedance amplifier 120. The capacitor 140 may change a voltage level of the output electric signal of the ROSA 130 based on a voltage level required by a limiting amplifier 150. That is, the voltage level of the electric signal output by the capacitor 140 may be identical to a voltage level of an input electric signal required by the limiting amplifier 150. A high-speed burst mode signal may pass through the capacitor 140 having an identical capacitance.

The optical signal receiving apparatus includes the limiting amplifier 150 configured to amplify the electric signal output by the capacitor 140. The limiting amplifier 150 may amplify the electric signal based on a preset voltage level. The preset voltage level may be determined to be a level appropriate for analyzing a digital value, 0 or 1, included in the electric signal. Referring to FIG. 1, the optical signal receiving apparatus includes a clock data generator 160 configured to generate a clock signal and a data signal from the electric signal output by the limiting amplifier 150. That is, the clock data generator 160 may separate or restore the clock signal and the data signal included in the electric signal output by the limiting amplifier 150.

The optical signal receiving apparatus includes a resistor 170 connected between the capacitor 140 and the limiting amplifier 150. FIG. 1 illustrates that the resistor 170 and the capacitor 140 are connected to the limiting amplifier 150 in parallel. In another example, the resistor 170 may be connected to the capacitor 140 and the limiting amplifier 150 in series. Hereinafter, it is assumed that the resistor 170 and the capacitor 140 are connected to the limiting amplifier 150 in parallel. The resistor 170 may be a variable resistor of which a resistance value is determined based on a control signal. A control signal transferred to the resistor 170 may be a reset signal defined in a passive optical network (PON) of the OLT including the optical signal receiving apparatus. The control signal may be generated by a controller (not shown) included in the optical signal receiving apparatus.

When the optical signal receiving apparatus receives different burst mode optical signals, a resistance value of the resistor 170 may be changed at an appropriate point in time to minimize a problem that a receiving, sensitivity of the optical signal receiving apparatus deteriorates. In an example, the resistance value of the resistor 170 may be changed based on, whether a time interval, that is, a time slot allocated to each of the ONUs being switched. In another example, the resistance value of the resistor 170 may be changed based on whether identical digital values are sequentially transmitted through the optical signal.

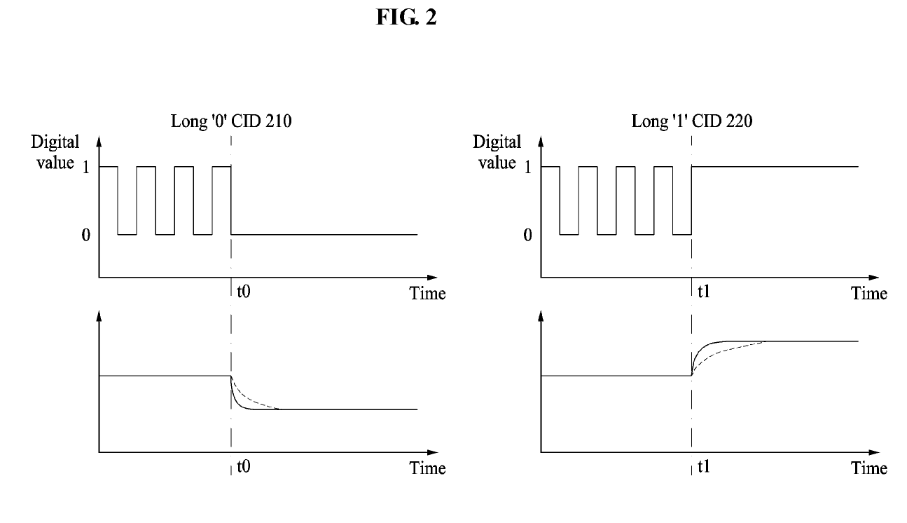

FIG. 2 illustrates a process in which a resistance value of a resistor of an optical signal, receiving apparatus is changed based on a digital value included in an optical signal according to an example embodiment. Art optical signal sequentially includes a plurality of ones or zeros A consecutive identical digit (CID) indicates that a plurality of ones or zeros are consecutively transmitted.

The optical signal receiving apparatus may determine a low cut-off frequency

$$\frac{1}{2 π RC}$$

corresponding to a lowest frequency to be received by the optical signal receiving apparatus based on a capacitor value C corresponding to an optical signal, for example, a burst mode optical signal, transmitted at high speed and a resistance value R measured from an input side of a limiting amplifier. That is, the optical signal receiving apparatus may be unable to receive a signal having, a frequency less than or equal to the low cut-off frequency and thus, a boss may occur. The optical signal receiving apparatus may verify whether an optical signal includes a plurality of ones (long ‘1’ CID) or the optical signal consecutively includes a plurality of zeros (long ‘0’ CID).

Referring to FIG. 2, when the optical signal consecutively includes zeros (long ‘0’ CID), changes in a digital value a low cut-off frequency over time are represented in a graph 210. Referring to the graph 210, zeros are consecutively transmitted subsequent to a point in time t0. When the optical signal consecutively includes ones (long ‘1’ CID), changes in a digital value a low cut-off frequency over time are represented in a graph 220. Referring to the graph 220, ones are consecutively transmitted subsequent to a point in time t1. Referring to the graphs 210 and 220, a relatively great amplitude of a low cut-off frequency is represented in a broken line and a relatively less amplitude of a low cut-off frequency is represented in a solid line. When the relatively great amplitude of low cut-off frequency is compared to the relatively less amplitude of low cut-off frequency, a CID feature, that is, a feature of receiving consecutively transmitted digital values may be enhanced as the amplitude of low cut-off frequency decreases. This is because an error occurs as a pattern dependent jitter occurs when consecutive ones or consecutive zeros pass through a circuit having a great time constant.

The optical signal receiving apparatus may determine a resistance value of a resistor based on the CID feature. That is, the optical signal receiving apparatus may reduce the low cut-off frequency by increasing the resistance value of the resistor at a point in time at which the optical signal is received. Thus, the CID feature may be enhanced, and the optical signal receiving apparatus may receive more accurate digital values that are consecutively input. In more detail, because the time constant is to be increased to enhance the CID feature, the optical signal receiving apparatus may reduce the low cut-off frequency by increasing the resistance value of the resistor. Conversely, because the time constant is to be decreased to enhance a settling time feature, the optical signal receiving apparatus may increase the low cut-off frequency by decreasing the resistance value of the resistor. As the low cut-off frequency increases, the time constant is reduced and thus, the optical signal receiving apparatus may more rapidly follow an average intensity of newly received optical signals.

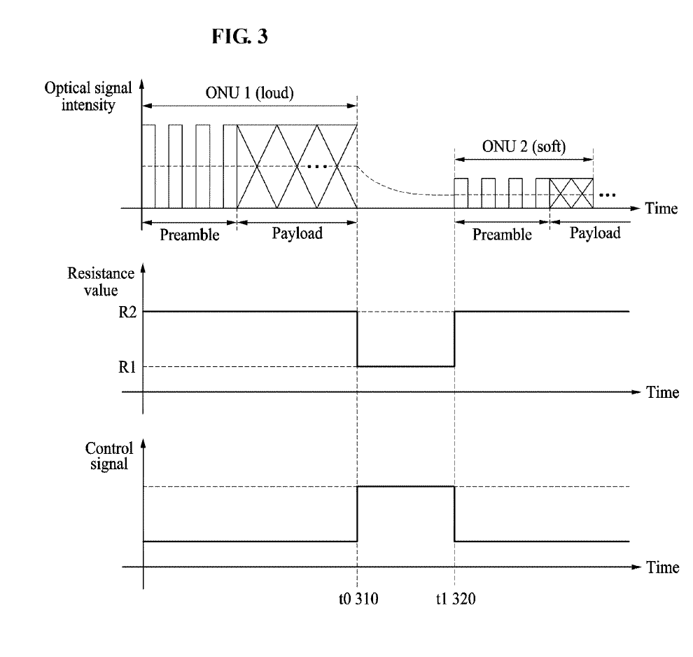

FIG. 3 illustrates a process in which a resistance value of a resistor of an optical signal receiving apparatus is determined based on burst mode optical signals received from different optical network units (ONUs) according to an example embodiment. FIG. 3 illustrates intensities of optical signals received by a first optical network unit (ONU) and a second ONU connected to an optical line terminal (OLT) including the optical signal receiving apparatus, a resistance value determined based on the intensities of optical signals, and a control signal as time elapses. It is assumed that the first ONU transmits an optical signal to the OLT until a point in time t0 310 and the second ONU transmits an optical signal to the OLT from a point in time t1 320 after a predetermined amount of time elapses subsequent to the point in time t0 310.

Because distances between the OLT and ONUs connected to the OLT vary, intensities of optical signals output by the ONUs to the OLT may be different depending on the distances between the OLT and the ONUS. That is, the optical signal receiving apparatus of the OLT may receive optical signals having different intensities. That is, it is more desirable that a range of optical signal to be received by the optical signal receiving apparatus is great. Further, when a plurality of ONUs transmit burst mode optical signals to the OLT, an intensity of an optical signal to be received by the optical signal receiving apparatus may be dynamically changed in response to the intensity of optical signal being changed. That is, as a dynamic range of the optical signal receiving apparatus is great, the OLT may smoothly receive the optical signals of the ONUS having more various distances.

It is assumed that a distance between the first ONU and the OLT is less than a distance between the second ONU and the OLT. The first ONU is closer to the OLT than the second ONU. Referring to FIG. 3, an intensity of a burst mode optical signal output by the first ONU may be greater than that of the second ONU. That is, the optical signal transmitted to the OLT by the first ONU is a burst mode optical signal corresponding to a loud burst signal of which a signal intensity is great. The optical signal transmitted to the OLT by the second ONU is a burst mode optical signal corresponding to a soft burst signal of which a signal intensity is less.

Because the intensity of optical signal of the first ONU is less than the intensity of optical signal of the second ONU, an average intensity (indicated in broken line in FIG. 3) of the optical signals received by the OLT may decrease over time. The optical signal receiving apparatus may calculate a time constant, RC, based on a given capacitor value C and a resistance value R measured by an input side of a limiting amplifier. Because the optical signal receiving apparatus more rapidly follows an average intensity of the received optical signals as a time constant calculated by the optical signal receiving apparatus decreases, that is, a loud and soft ratio feature, a feature of following an intensity of a newly received optical signal, may be enhanced as a resistance value of a resistor of the optical signal receiving apparatus decreases. That is, the time constant decreases as the resistance value decreases and thus, an amount of time used to follow an average intensity of next optical signals may be reduced.

When a capacitance of a capacitor, for example, the capacitor 140 of FIG. 1, connecting a receiving optical sub-assembly (ROSA) and a limiting amplifier is fixed, a consecutive identical digit (CID) feature may be enhanced as a resistance value of a resistor, for example, the resistor 170 of FIG. 1, disposed between the capacitor and the limiting amplifier increases and a loud and soft ratio feature may be enhanced as the resistance value decreases. Because ones or zeros are consecutively received when receiving the optical signals, the CID feature may be enhanced at a point time at which the optical signals are received. Because intensities of optical signals vary depending on the ONUs, the loud and soft ratio feature is to be enhanced at a point in time at which an ONU transmitting an optical signal is changed. The optical signal receiving apparatus may adjust the resistance value of the resistor based on which of the CID feature or the loud and soft ratio feature is more significant.

Referring to FIG. 3, the optical signal receiving apparatus may change the resistance value of the resistor to be a relatively great value R2 based on the CID feature during a time interval before the point in time t0 310 or a time interval after the point in time t1 320, that is, a time interval during which the first ONU or the second ONU is transmitting an optical signal. For example, the capacitor connecting the ROSA and the limiting amplifier generally uses a capacitor in a range of 82 pF through 470 pF, and the resistor disposed between the capacitor and the limiting amplifier may correspond to a variable resistor having a range from 5Ω to 5Ω, that is, a variable resistor of which a difference between a minimum resistance value and a maximum resistance value is about 1000 times.

In more detail, the optical signal receiving apparatus may transmit a control signal being a preset signal Low to the resistor and change the resistance value of the resistor to be the relatively great value R2. Thus, the optical signal receiving apparatus may receive an optical signal corresponding to a bandwidth without a data loss.

Referring to FIG. 3, the optical signal receiving apparatus may change the resistance value of the resistor to be a relatively less value R1 based on the loud and soft ratio feature during a time interval between the point in time t0 310 and the point in time t1 320, that is, a time interval between a point in time at which the first ONU completes a transmission of the optical signal and a point in time at which the second ONU outputs the optical signal. In more detail, the optical signal receiving apparatus may transfer a control signal being a preset signal High to the resistor, and change the resistance value of the resistor to be the relatively less value R1. In response to the resistance value of the resistor being changed to be the relatively less value R1, the loud and soft ratio feature may be enhanced and thus, the optical signal receiving apparatus may rapidly follow an intensity of a newly received optical signal.

In more detail, in response to the resistance value of the resistor being changed to be the relatively less value R1, an amount of settling time of the optical signal receiving apparatus may be reduced. The amount of settling time indicates an amount of time used to switch the optical signal receiving apparatus corresponding to the changed intensity of optical signal when the intensity of optical signal is changed in response to the ONU transmitting the optical signal to the OLT being changed. The optical signal receiving apparatus may be unable to receive the optical signal during the settling time.

As the amount of settling time is reduced, a signal transmission quality may be prevented from a deterioration due to a signal loss. Because the signal transmission quality is prevented from deterioration, a transmission efficiency may be enhanced. Because the optical signal receiving apparatus is unable to receive the optical signal during the settling time, an amount of time in which the optical signal receiving apparatus is unable to receive the optical signal may be also reduced as the amount of settling time is reduced. That is, a length of a time interval, for example, a time interval between the point in time t0 310 and the point in time t1 320, to be inserted between time intervals during which the ONUs transmit optical signals may decrease. Thus, a network efficiency of the OLT including the optical signal receiving apparatus may be enhanced.

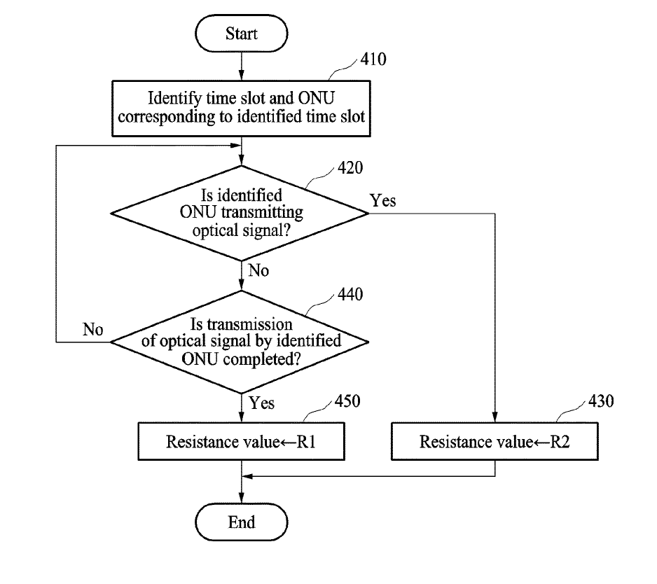

FIG. 4 is a flowchart illustrating an operation of an optical signal receiving apparatus according to an example embodiment. The optical signal receiving apparatus includes a resistor disposed between a limiting amplifier and a capacitor configured to adjust a voltage level of an electric signal output by a receiving optical sub-assembly (ROSA).

Referring to FIG. 4, in operation 410, the optical signal receiving apparatus identifies a time slot corresponding to a current time and identifies an optical network unit (ONU), that is, an ONU to which a time slot is allocated, corresponding to the identified time slot. An optical line terminal (OLT) including the optical signal receiving apparatus may allocate a time slot being a unit for classifying a time to the ONU. Different time slots may be allocated to a plurality of ONUs connected to the OLT. A plurality of consecutive time slots may be allocated to the ONUs. When the ONUs exclusively use the allocated time slots, at least one idle time slot depending on a settling time may exist between the time slots used by the ONUs. An idle time slot indicates a time slot during which an ONU is unable to transmit an optical signal.

In operation 420, the optical signal receiving apparatus verifies whether the identified ONU transmits an optical signal. That is, the optical signal receiving apparatus may verify whether an ONU transmitting an optical signal exists during the time slot corresponding to the current time. When the identified ONU transmits the optical signal, that is, when the ONU transmitting the optical signal exists, the optical signal receiving apparatus sets a resistance value to a preset resistance value, for example, R2 of FIG. 3, based on a consecutive identical digit (CID) feature in operation 430. Thus, the optical signal receiving apparatus may reduce a loss occurring when data included in the optical signal is received.

When the identified ONU is unable to transmit the optical signal, the optical signal receiving apparatus verifies whether the identified ONU completes a transmission of the optical signal in operation 440. That is, when the ONU transmitting the optical signal is absent, the optical signal receiving apparatus may verify whether an ONU other than the ONU that has transmitted the optical signal is to transmit the optical signal. When the identified ONU completes the transmission of the optical signal, that is, when the ONU other than the ONU that has transmitted the optical signal transmits the optical signal, the optical signal receiving apparatus sets a resistance value to a preset resistance value, for example, R1 of FIG. 3, based on a loud and soft ratio feature. Accordingly, an amount of settling time of the optical signal receiving apparatus is reduced such that the optical signal receiving apparatus may more rapidly manage a change in an intensity of the optical signal may be dealt with more rapidly.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical signal receiving apparatus comprising:
a receiving optical sub-assembly (ROSA) configured to convert an optical signal transmitted during a time interval allocated to each of a plurality of optical network units (ONUs) into an electric signal;
a capacitor connected to the ROSA;
an amplifier configured to amplify an electric signal output from the capacitor;
a clock data generator configured to generate a clock signal and a data signal from the electric signal output from the amplifier; and
a resistor connected between the capacitor and the amplifier,
wherein a resistance value of the resistor is changed based on whether the time interval is switched.

2. The optical signal receiving apparatus of claim 1, wherein the resistance value of the resistor is changed to be a first resistance value set in advance in response to the time interval being switched, and changed to be a second resistance value greater than the first resistance value while receiving the optical signal during a switched time interval in response to switching of the time interval being completed.

3. The optical signal receiving apparatus of claim 2, wherein the first resistance value is determined based on intensities of optical signals generated by the ONUs.

4. The optical signal receiving apparatus of claim 2, wherein the second resistance value is determined based on a number of ones or zeroes that are sequentially included in the optical signal in response to the optical signal received during the switched time interval sequentially including ones or zeroes.
